(19) United States
(12) Patent Application Publication
(10) Pub. No.: US 2010/0306511 A1
(43) Pub. Date: Dec. 2, 2010

(54) COMMUNICATION DATA PROCESSOR AND COMMUNICATION DATA PROCESSING METHOD

(75) Inventors: Yoshinori Mochizuki, Sagamihara (JP); Takatoshi Kato, Yokohama (JP); Nobuaki Kohinata, Yokohama (JP); Shigeki Taira, Yokohama (JP)

Correspondence Address: MATTINGLY & MALUR, P.C., 1800 DIAGONAL ROAD, SUITE 370, ALEXANDRIA, VA, 22314, US

(73) Assignee: RENESAS ELECTRONICS CORPORATION, Kanagawa (JP)

(21) Appl. No.: 12/787,421

(22) Filed: May 26, 2010

(30) Foreign Application Priority Data
May 29, 2009 (JP) 2009-131108

(51) Int. Cl. G06F 9/312

(52) U.S. Cl. 712/225; 712/E09.033

(57) ABSTRACT

There is a need for providing a communication data processor easily adaptable to network configurations required for industrial Ethernet. The apparatus successively analyzes received packets. The apparatus uses a register to determine whether or not to transmit the received packet as transmission data to another port. Rewritable memory saves a program code that provides control for analyzing a reception packet and generating a transmission packet. The apparatus is capable of complying with various communication protocols by changing the program code.

### CLAIM OF PRIORITY

The present application claims priority from Japanese patent application JP 2009-131108 filed on May 29, 2009, the content of which is hereby incorporated by reference into this application.

### BACKGROUND

The present invention relates to a communication data processor and a communication data processing method capable of efficiently processing real-time communication data for communication terminals.

Conventionally, factories use a field bus such as PROFIBUS (registered trademark) or SERCOS (registered trademark) for data communication between a programmable logic controller (PLC), a sensor, and an inverter. Presently, however, factories are extensively automated to increase the quantity of data exchanged over the network between devices. The existing field bus becomes incapable of processing the increasing quantity of data. Industrial Ethernet (registered trademark) provides a solution for this problem. The industrial Ethernet is application of Ethernet used for a local area network (LAN) or the like to the field bus. The industrial Ethernet provides more improved real-time property and reliability than conventional Ethernet. The industrial Ethernet enables faster data communication than the field bus. In the future, the industrial Ethernet is expected to be used for many communication purposes in factories. Industrial Ethernet standards include Ethercat (registered trademark) and PRFINET (registered trademark).

Presently, multiple industrial Ethernet standards are available because the industrial Ethernet standardization is in progress including compatibility with conventional field buses. Multiple industrial Ethernet standards may be integrated but are still expected to remain in the future.

A processing apparatus includes a general-purpose processor and a storage device. The storage device stores a program for protocol processes. The general-purpose processor executes the program to perform a communication protocol process. The apparatus provides a software-based protocol process.

Japanese patent laid-open No. 1996-181715 proposes a communication protocol process using hardware or an apparatus dedicated to protocol processes. In other words, the hardware-based protocol process provides the communication protocol process. The above-mentioned document describes the communication protocol processing method using a transmission/reception apparatus that efficiently transmits and receives data.

### SUMMARY

However, communication protocol processing apparatuses according to the conventional technology may cause the following problems.

Firstly, the industrial Ethernet, unlike Ethernet used for LAN, needs to comply with line, tree, and the other topologies. The conventional technology gives no consideration for such topologies. It is necessary to include a feature compatible with the topologies.

Secondly, there are multiple standards for the industrial Ethernet. The conventional technology uses an apparatus for processing received packets and an apparatus for generating packets to be transmitted as special hardware independent of each other. The conventional technology needs different types of hardware compliant with different standards. Developing and using special hardware for different protocols may expand the scale of circuits and programs used for the communication apparatus or increase production lines. This may not be cost-effective.

The invention provides a communication data processor easily adaptable to network configurations required for industrial Ethernet.

More specifically, the invention provides a communication data processor and a communication data processing method easily adaptable to required network topologies and network protocols. In other words, the invention is applicable to various communication protocol processes including the real-time communication protocol at low costs.

These and other objects and novel features of the invention may be readily ascertained by referring to the following description and appended drawings.

A representative example apparatus disclosed in the invention is simply summarized below.

The apparatus successively receives packets and analyzes them. The apparatus directly transmits the received packet as transmission data to another port. The apparatus allows a register to configure the timing to transmit the data to another port. Rewritable memory saves a microcode for successively analyzing a received packet and successively generating a packet to be transmitted. The microcode can be easily changed. Registers are used for communication protocol specifications. In this manner, the apparatus is capable of complying with various communication protocols.

The invention is applicable to various communication protocol processes including the real-time communication protocol at low costs.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is an explanatory diagram exemplarily showing the topology configuration according to Ethercat;

FIG. 2 is an explanatory diagram showing the configuration of one Ethercat frame;

FIG. 3 is a block diagram exemplarily showing the hardware configuration of a communication terminal according to a first embodiment provided with a feature that successively receives and processes frames and transmits a received frame to an adjacent communication terminal within a specified period;

FIG. 4 is a block diagram exemplarily showing the hardware configuration of a controller;

FIG. 5 is a block diagram exemplarily showing the hardware configuration of a reception analysis section;

FIG. 6 is a block diagram exemplarily showing the hardware configuration of a transmission generation section;

FIG. 7 is a block diagram exemplarily showing the hardware configuration of a transmission/reception data control section;

FIG. 8 is a flowchart exemplarily showing a startup sequence after turning on the communication terminal;

FIG. 9 is a flowchart exemplarily showing a procedure for processing data received from a signal process section;

FIG. 10 is a flowchart exemplarily showing a procedure for analyzing an analysis result;

FIG. 11 is an explanatory diagram exemplarily showing a synchronization system compliant with IEEE 1588;

FIG. 12 is a block diagram exemplarily showing the hardware configuration of a communication terminal according to a second embodiment; and

FIG. 13 is a flowchart exemplarily showing a startup sequence after turning on a communication terminal 1200.

### DETAILED DESCRIPTION OF THE EMBODIMENTS

### 1. Summary of the Preferred Embodiments

The following gives an overview of representative embodiments of the present invention disclosed in the application concerned. The overview includes parenthesized reference numerals in the accompanying drawings. The reference numerals merely denote corresponding elements belonging to the concept thereof.

[1] A communication data processor (300, 1200) according to the representative embodiments includes: a data process section (380); a communication interface (301) having a plurality of outside interface ports; and a communication process section (370) that performs communication control using the communication interface in accordance with a setting of the data process section. The communication process section includes: rewritable memory (440) that stores a program code for program control over the communication process section in accordance with a specified communication protocol; and a first mode register (422) that specifies an operation of transmitting data received via the communication interface from a port different from a receiving port. The communication process section references the first mode register and controls transmission/reception via the communication interface in accordance with a program code stored in the memory.

The apparatus is capable of communication operations compliant with a communication protocol corresponding to a program code stored in the memory. A reception port and a transmission port can be provided independently, making it possible to comply with a linear communication topology. The apparatus is easily adaptable to various communication protocols. The apparatus is applicable to various communication protocol processes including the real-time communication protocol at low cost.

[2] In the communication data processor according to item 1, the communication process section includes a timing register (423) that variably specifies timing of transmission from the different port. For example, a linear communication topology can be configured to directly pass reception data to a subsequent communication terminal or to process reception data as needed, provide the data with a process result, and pass the data to a subsequent communication terminal. Also in this respect, the apparatus is capable of complying with various communication protocols. The communication control can be more flexible.

[3] In the communication data processor according to item 2, the communication process section includes a second mode register (421) that is assigned with data indicating a communication protocol corresponding to a program code stored in the memory. Reference to a value in the second mode register makes it possible to easily determine to which communication protocol the program code currently stored in the memory corresponds. Reference to a setup value in the second mode register also makes it possible to determine the type of a program code to be stored in the memory.

[4] In the communication data processor according to item 3, the data process section includes a processor (350) that accesses the first mode register, the second mode register, and the timing register.

[5] In the communication data processor according to item 3 or 4, the communication process section analyzes input reception data and provides communication control based on an analysis result. In addition, the communication process section provides control of outputting the input reception data from another port in accordance with settings of the second mode register and the timing register independently of completion of control based on the analysis result. For example, a linear communication topology can be configured to directly pass reception data to a subsequent communication terminal or to process reception data as needed, provide the data with a process result, and pass the data to a subsequent communication terminal.

[6] In the communication data processor according to any one of items 1 through 5, the data process section includes nonvolatile memory (341) that contains a program code to be stored in the memory. The data process section initially allocates a program code from the nonvolatile memory to the memory.

[7] In the communication data processor according to any one of items 1 through 5, the data process section includes an input circuit (360, 1280). The data process section initially allocates a program code supplied from the input circuit to the memory.

[8] A communication data processing method according to the representative embodiments is provided for communication control using a data process section, a communication interface having a plurality of outside interface ports, and a communication process section that performs communication control using the communication interface in accordance with a setting of the data process section. The method includes the steps of: allowing the data process section to store a program code in rewritable memory, wherein the program code is used for program control over the communication process section in accordance with a specified communication protocol; allowing the data process section to assign data to a first mode register of the communication process section, wherein the data specifies a transmission port using a port different from a reception port for the communication interface; and allowing the communication process section to reference setup data in the first mode register and perform a transmission/reception operation in accordance with a program code stored in the memory.

The method is easily adaptable to various communication protocols. The method is applicable to various communication protocol processes including the real-time communication protocol at low cost.

[9] The communication data processing method according to item 8 further includes the steps of: allowing the data process section to assign a timing register of the communication process section with data that variably specifies timing of transmission from the different port; and allowing the communication process section to control timing to transmit data received through the communication interface in accordance with setup data in the timing register.

[10] The communication data processing method according to item 9 further includes the step of: allowing the data process section to assign a second mode register of the communication process section with data that indicates a communication protocol corresponding to a program code stored in the memory.

### 2. Further Detailed Description of the Preferred Embodiments

The embodiments are described in more detail below.

### First Embodiment

The following description discusses Ethercat as an example of communication protocols. Ethercat is one of industrial Ethernet standards. The disclosed contents may be applicable to industrial Ethernets other than Ethercat and to the other communication protocols in which a one-frame configuration includes a data transmission origin address, a data transmission destination address, and transmission/reception data. The one-frame configuration may include a data length, a data type, an error correction code, and the like.

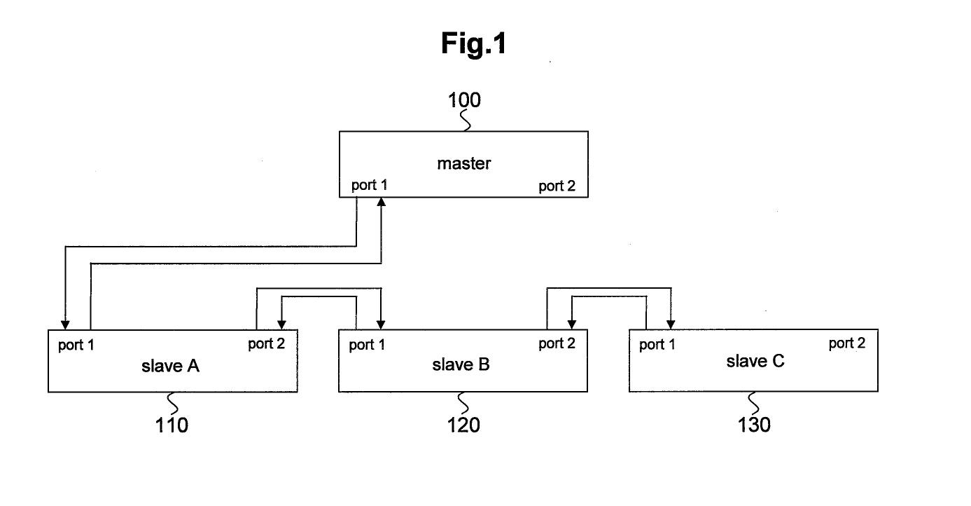

FIG. 1 exemplarily shows the topology configuration (communication topology) according to Ethercat.

As shown in FIG. 1, Ethercat includes one master and multiple slaves. The slave functions as a communication terminal or includes it. The configuration is applicable to a line topology in which data is transmitted from the master, is processed in each slave, and then returns to the master. Data transmitted from a master 100 reaches a port 1 of a slave A110. The slave A110 processes the data and then transmits it to a slave B120 via a port 2. The slave B120 similarly processes the data and then transmits it to the port 1 of a slave C130. The slave C130 receives the data, processes it, and then transmits it to the port 2 of the slave B120. A similar process can be performed subsequently to transmit the data to the master 100. When the line communication topology is used, as seen from FIG. 1, the terminal slave needs to use the same port to transmit and receive data. The other slaves need to use multiple independent port to transmit and receive data.

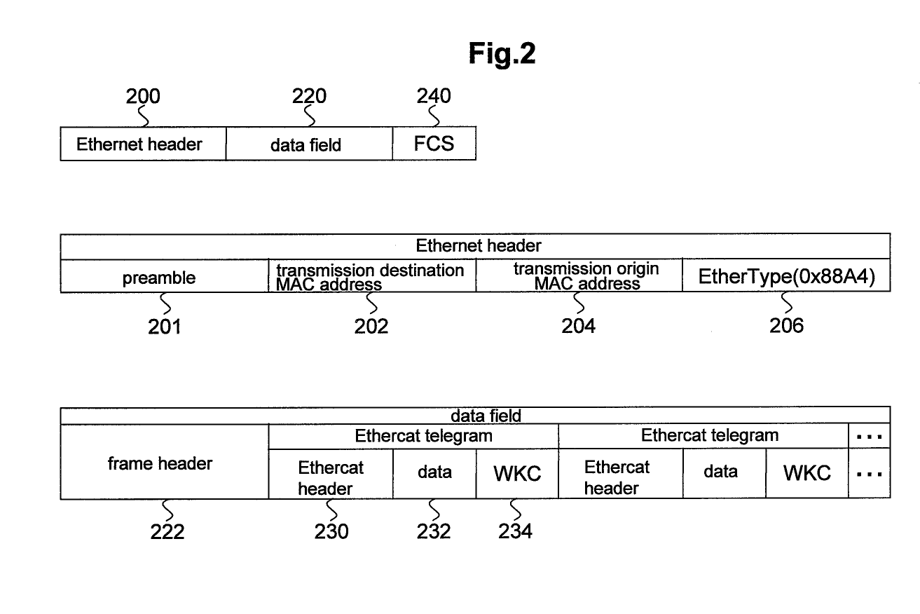

FIG. 2 shows an Ethercat frame configuration. The frame configuration includes an Ethernet header 200, a data field 220, and an frame check sequence (FCS) 240 for error correction.

The Ethernet header 200 includes an MAC address 202 as frame transmission destination, an MAC address 204 as frame transmission origin, and type 0x88A4 indicating that the frame is Ethercat. The Ethercat frame assigns a segment address included in each slave, not an address of each slave itself, to the MAC address 202 as frame transmission destination. Each slave address is assigned to an Ethercat header 230 to be described later.

The data field 220 includes a 2-byte frame header 222 and multiple Ethercat telegrams. The frame header 222 defines the data length of the whole one frame.

Each Ethercat telegram includes an Ethercat header 230, data 232, and WKC 234. The Ethercat header 230 includes the address (address of a slave in a segment specified by MAC address 202) of a slave that uses the data 232 for processing and processing contents. The processing contents include writing to or reading from the memory, asynchronous processing, and application processing. The WKC (write counter) 234 is used to increment a value by one so as to notify the master 100 that the slave has performed the process indicated by the Ethercat header 230. The WKC 234 is incremented by 1 when the slave performs the processing content.

The following outlines the process flow of slaves that process the Ethercat frame according to the topology configuration in FIG. 1.

The master 100 allocates necessary values to the fields in FIG. 2 and then transmits the frame to the port 1 of the slave A110. The slave A110 receives the frame and determines whether or not the Ethercat header 230 in each Ethercat telegram contains an address indicating the slave A110 itself. When that address is found, the slave A110 performs a process indicated by the Ethercat header 230. When the process terminates, the slave A110 increments the value of the WKC 234 by one and transmits the frame to the port 1 of the slave B120. When transmitting the frame to the slave B120, the slave A110 does nothing to fields that are unrelated to its specific processes. When changing even part of the received frame, the slave A110 also changes the value of an FCS240 field in the frame to be transmitted to the slave B120.

When the Ethercat header 230 contains no address indicating the slave A110 itself, the slave A110 does nothing and transmits the received frame to the slave B120.

An Ethercat frame needs to be transmitted to the next slave within a specified period. The slave needs to transmit the frame without incrementing the WKC 234 when the process indicated by the Ethercat header 230 does not terminate with the specified period.

There may be a process flow that receives all elements contained in the frame, processes the frame, and transmits the frame to an adjacent communication terminal. It is difficult to apply such process flow to the real-time industrial Ethernet. To solve this problem, a communication terminal needs to be provided with a feature that successively receives and processes frames and transmits the received frames to an adjacent slave (communication terminal) within a specified period.

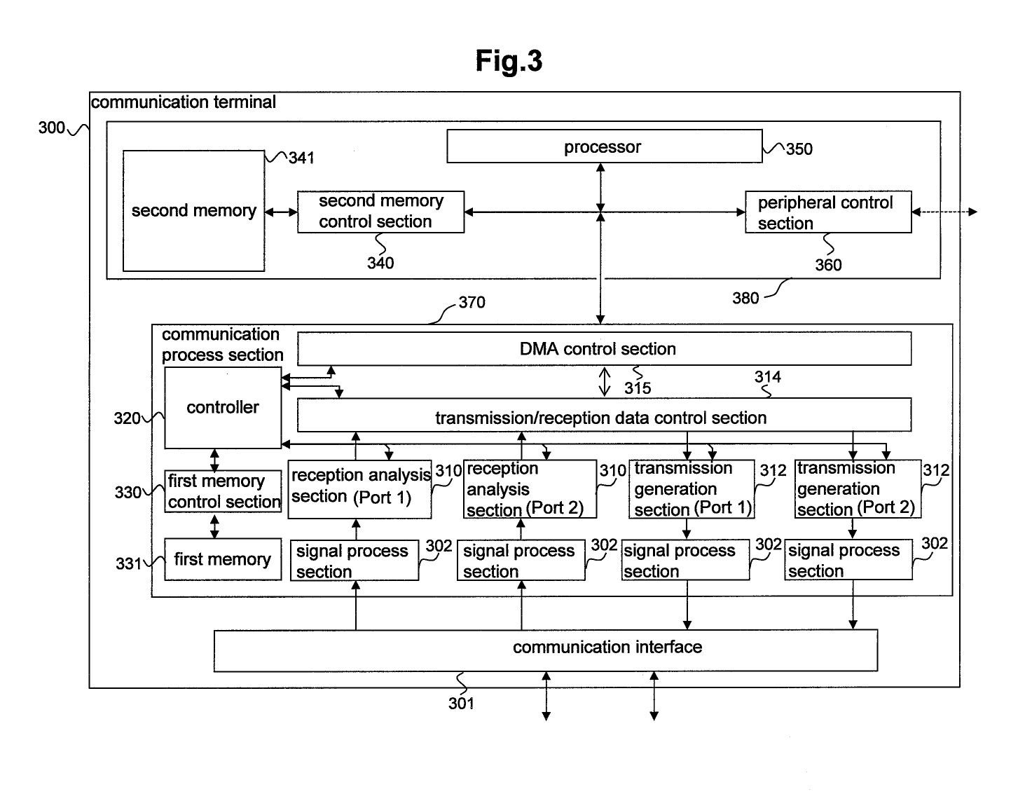

FIG. 3 shows the hardware configuration of a communication terminal according to the first embodiment in which the communication terminal is provided with a feature that successively receives and processes frames and transmits the received frames to an adjacent communication terminal within a specified period. Though not particularly specified, a communication terminal 300 in FIG. 3 may be configured as: a one-chip semiconductor integrated circuit configured over a single semiconductor substrate of single-crystal silicon, for example, in accordance with the complementary MOS integrated circuit manufacturing technology; a module device that contains multiple chips over a module substrate and is sealed into a single package; or a multi-chip card device that contains multiple semiconductor integrated circuits over a circuit substrate.

The communication terminal 300 includes a communication interface 301, a communication process section 370, and a data process section 380. The communication process section 370 includes a signal process section 302, a reception analysis section 310, a transmission generation section 312, a transmission/reception data control section 314, a DMA control section 315, a controller 320, a first memory control section 330, and first memory 331. The data process section 380 includes a second memory control section 340, second memory 341, a processor 350, and a peripheral control section 360. The peripheral control section 360 is coupled to an unshown auxiliary storage device or other peripheral circuits. The communication terminal 300 may be provided with a magnetic disk unit or other storage units and a display panel (not shown) coupled to the peripheral control section 360 or the like in accordance with services and applications available for the communication terminal 300. The signal process section 302 is provided for each of the transmission and reception ports of port 1 and those of port 2 according to the configuration for the communication interface as shown in FIG. 3. In addition, the signal process section 302 may be provided in common with all the ports. The number of ports is not limited to two, namely, ports 1 and 2. One or more reception analysis sections 310 and transmission generation sections 312 may be provided in accordance with services and applications available for the communication terminal 300.

The communication terminal 300 communicates with an unshown communication terminal through the communication interface 301. The communication terminal 300 includes internal circuit modules that each operate at a specified interval of time. The interval is referred to as a cycle in the following description. For example, one cycle signifies the unit of operational interval. The first cycle signifies the first operational interval, and so on.

The signal process section 302 is equivalent to a circuit for performing processes so that the communication terminal 300 is coupled to a network through the communication interface 301. The communication interface 301 may be assumed to be a physical layer according to the OSI (Open Systems Interconnection) reference model. In this case, the signal process section 302 converts bits or adjusts clocks. The signal process section 302 may be used for modulation or demodulation in accordance with communication interfaces to be used. The industrial Ethernet uses 4-bit data for the communication interface 301. Each module performs processes on a 4-bit basis. In addition, the process unit may be varied in accordance with communication interfaces to be used. In the following description, reception data and transmission data signify part of data contained in a reception frame and a transmission frame.

The controller 320, the transmission/reception data control section 314, the reception analysis section 310, and the transmission generation section 310 will be described in further detail with reference to the accompanying drawings. A DMA control section 315 controls DMA transfer in accordance with instructions from the controller 320 and the like. The first memory represents fast SRAM and is used as a buffer or cache memory. The first memory control section 330 controls operations of the first memory. The processor 350 of the data process section 380 provides overall control for the communication terminal 300 and performs specific arithmetic operations. The second memory 341 represents nonvolatile memory such as electrically rewritable flash memory. The second memory control section 340 controls operations of the second memory.

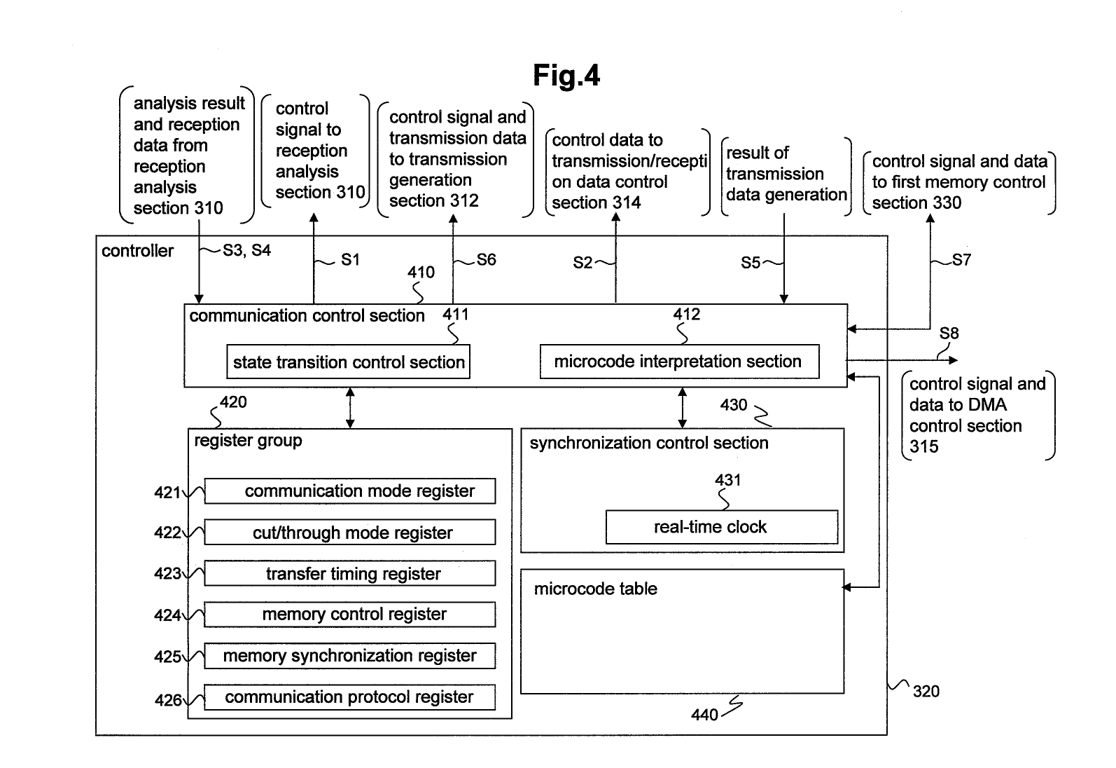

FIG. 4 exemplarily shows the hardware configuration of the controller 320. The controller 320 includes a communication control section 410, a register group 420, a synchronization control section 430, and a microcode table 440.

The communication control section 410 provides control so that the reception analysis section 310 and the transmission generation section 312 can perform processes in accordance with the communication protocol. The communication control section 410 includes a state transition control section 411 and uses it to provide this control. When data is received, the communication control section 410 is supplied with an analysis result S3 and data S4 transmitted from the reception analysis section 310. When data is received, the state transition control section 411 uses the analysis result S3 transmitted from the reception analysis section 310 and confirms that the received data is appropriate for the communication state. The state transition control section 411 transmits a control signal S1 to specify which reception data the reception analysis section 310 needs to analyze. To do this, for example, the state transition control section 411 extracts an instruction from the microcode table 440. The instruction specifies which process the reception analysis section 310 needs to perform next. A microcode interpretation section 412 changes the instruction into a control signal. The changed control signal S1 is supplied to the reception analysis section 310. According to the Ethercatt configuration, for example, the 6-byte MAC address 204 as frame reception origin is followed by a 2-byte type 206 (0x88A4). The state transition control section 411 receives the analysis result of correctly receiving the 6-byte MAC address 204 from the reception analysis section 310. The state transition control section 411 then references the microcode table 440 and extracts an instruction the reception analysis section 310 performs next. According to the example, the instruction compares 0x88A4 with the 2-byte reception data. The microcode interpretation section 412 changes the instruction to the control signal S1 and transmits the signal to the reception analysis section 310.

When one frame of data is completely received, an analysis result may necessitate the second memory 341 to save the reception data stored in the transmission/reception data control section 314. In such case, the communication control section 410 uses the signal S2 for requesting the transmission/reception data control section 314 to save the data in the second memory 341 via the DMA control section 315.

When data is transmitted, the transmission generation section 312 transmits a generation result (transmission data generation result) S5. Using the result S5, the state transition control section 411 confirms that data appropriate for the communication state is generated and transmitted. The state transition control section 411 supplies the transmission generation section 312 with a control signal S6 as an instruction to generate transmission data. The method uses the microcode similarly to the reception analysis section 310 and a detailed description is omitted for simplicity.

Transmission frame types vary with communication protocols. Normally, a communication terminal itself generates a transmission frame from scratch. By contrast, Ethercat inserts data stored in the memory into part of the received frame. This frame is used as a transmission frame and is transmitted to the other communication terminals. In such case, the real-time property may not be ensured when the memory is accessed via the DMA control section 315. Ethercat modifies only part of received data and transmits the data to the other communication terminals. Such data is referred to as transfer data.

To solve this problem, the embodiment uses the first memory 331 the controller 320 can directly access without going through the DMA control section 315. A control signal and data depicted by S7 in FIG. 4 are supplied to the first memory control section 330 to access the first memory 331. The reception analysis section 310 and the transmission generation section 312 can be configured to access the first memory 331.

Based on an analysis result from the reception analysis section 310, the state transition control section 411 may determine that data stored in the first memory 331 needs to be inserted. In this case, the state transition control section 411 allows the first memory control section 330 to read data stored in the first memory 331 and allocates the data to the transmission buffer 630 in the transmission generation section 312. In accordance with the state of generated data, the state transition control section 411 issues an instruction to transmit the data allocated to the transmission buffer 630. The transmission buffer 630 may be contained in the communication control section 410. The real-time property may be ensured even when the above-mentioned process includes the DMA control section 315, i.e., even when data in the second memory 341 is inserted. In such case, the above-mentioned process may go through the DMA control section 315 using a signal S8 in FIG. 4.

The industrial Ethernet provides various standards that are extended versions of Ethernet standards. Accordingly, the industrial Ethernet uses almost the same process flows and almost the same operators. A microcode controls operators to be used. Simply changing the microcomputer can also change the communication protocol the communication terminal 300 uses. To change the communication protocol, the microcode table 440 preferably uses rewritable memory such as EEPROM and RAM. When RAM is used, a power-on reset process may initially load a necessary program code into the microcode table 440 from the second memory 341.

The register group 420 is necessary for operations of the communication terminal 300. The register group 420 includes a communication mode register 421, a cut/through mode register 422, a transfer timing register 423, a memory control register 424, a memory synchronization register 425, and a communication protocol register 426. During the power-on reset process, for example, the processor 350 initializes the registers in the register group 420 with initialization data the processor 350 may read from the second memory or from a peripheral circuit coupled to the peripheral control section 360.

The communication mode register 420 contains communication protocol types such as Ethercat and PROFINET for the communication terminal 300 to perform processes. The communication protocol type is equivalent to data that indicates a communication protocol controlled by a micro program stored in the microcode table 440. For example, the processor 350 references data stored in the communication mode register 420 to determine a micro program that needs to be transferred to the microcode table 440 from the second memory 341.

The cut/through mode register 422 specifies one of operation modes, i.e., cut mode and through mode, for operating the communication terminal. When data is received via the communication interface 410, the through mode transmits that data to another communication terminal within a cycle indicated by the transfer timing register 423. The cut mode does not.

The transfer timing register 423 indicates a cycle of transmitting reception data to another communication terminal. When the register is assigned value 10, for example, reception data is transmitted to another communication terminal 10 cycles after the data is transmitted from the signal process section 302.

The memory control register 424 chooses between the first memory 331 and the second memory 341 for accessing data depending on the application and the type of received data.

The memory synchronization register 425 copies data saved in the first memory 331 to the second memory 341. The register can be assigned the number of cycles, the number of reception packets, and the time. The register value, when reached, starts control to copy the content of the first memory 331 to the second memory 341.

The communication protocol register 426 is needed for protocol processes. When Ethercat is used as the communication protocol, for example, the communication protocol register 426 contains information needed for FMMU processes or SYNC Manager processes. In other words, the communication protocol register 426 is used as a control register needed for communication in the communication mode indicated by the communication mode register 421.

Unlike ETHERNET, the industrial Ethernet places importance on the real-time property and needs to accurately synchronize with the other communication terminals. The synchronization control section 430 performs synchronization processes compliant with protocols. The synchronization control section 430 includes a real-time clock 431 and uses the time indicated by the real-time clock 431 to manage the time in synchronization with the other communication terminals.

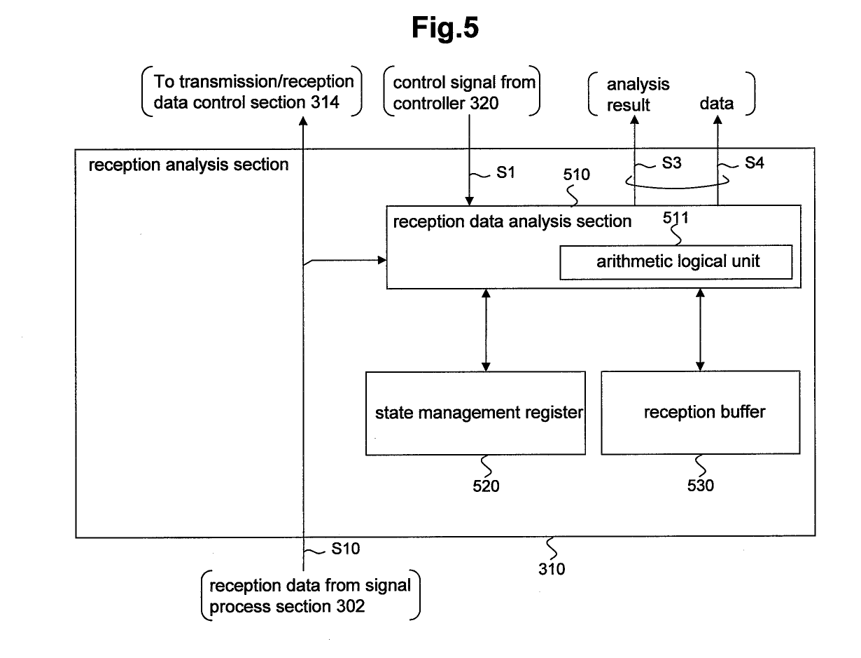

FIG. 5 exemplarily shows the hardware configuration of the reception analysis section 310. The reception analysis section 310 analyzes a reception packet S10 received via the communication interface 301. The reception analysis section 310 includes a reception data analysis section 510, a state management register 520, and a reception buffer 530.

The reception data analysis section 510 includes an arithmetic logical unit 511. The reception data analysis section 510 uses the arithmetic logical unit 511 to analyze and process received data.

Reception data S10 is supplied from the signal process section 302 and is stored in the reception buffer 530 in the reception analysis section 310. The reception data analysis section 510 stores the reception data so as to satisfy the data length specified by the controller 320. Based on the control signal S1 that the controller 320 transmits, the reception data analysis section 510 then analyzes the reception data using the arithmetic logical unit 511. The analyzed result is notified to the controller 320 or is stored in the state management register 520.

The following describes processes of the reception data analysis section 510 when Ethercat is specified. The controller 320 previously transmits an instruction to the reception data analysis section 510 so as to store 6-byte transmission data in the reception buffer 530 and compare the stored data with the MAC address of the master stored in the state management register 520. The state management register 520 stores data needed to analyze received data. The reception data analysis section 510 detects that the 6-byte data is allocated to the reception data buffer 530. The reception data analysis section 510 uses a comparator in the arithmetic logical unit 511 and compares the 6-byte data stored in the reception data buffer 530 with the address of the master stored in the state management register 520. The reception data analysis section 510 transmits the comparison result as a signal S3 to the controller 320.

When the 6-byte data matches the master address, the controller 320 then allows the reception buffer 530 to store 2-byte data and compare the data with the type value stored in the state management register 520.

The controller 320 performs the above-mentioned process each time data is received via the communication interface 301. The controller 320 may transmit only the control signal S1 as an analysis instruction to the reception data analysis section 510 without using the state management register 520.

The data S10 transmitted from the signal process section 302 is stored in the reception buffer 530 and is also directly transmitted to the transmission/reception data control section 314.

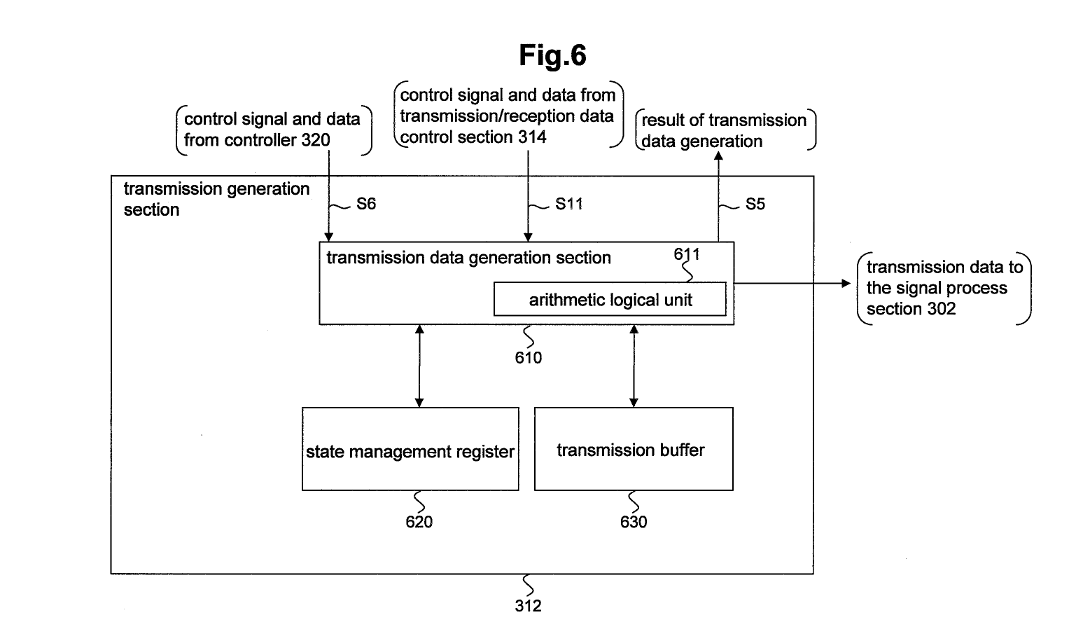

FIG. 6 exemplarily shows the hardware configuration of the transmission generation section 312. The transmission generation section 312 generates transmission data that is transmitted to the other communication terminals via the communication interface 301. The transmission generation section 312 includes a transmission data generation section 610, a state management register 620, and a transmission buffer 630.

The transmission data generation section 610 includes an arithmetic logical unit 611. The transmission data generation section 610 uses the arithmetic logical unit 611 to generate and process data to be transmitted. The arithmetic logical unit 611 and the state management register 620 may be configured in common with the arithmetic logical unit 511 and the state management register 520 provided for the reception analysis section 310.

The controller 320 transmits the control signal S6. Based on the control signal S6, the transmission data generation section 610 uses the arithmetic logical unit 611 to generate transmission data. The transmission data generation section 610 notifies the generated result to the controller 320 or allocates it to the state management register 620.

The following describes a flow of transmission data generation in the transmission data generation section 610 using an example of transmitting the Ethernet header 200.

The controller 320 previously supplies the transmission data generation section 610 with a process instruction that transmits the 6-byte transmission destination MAC address as transmission data stored in the state management register 620. The state management register 620 stores data needed to generate data.

The transmission data generation section 610 transmits the 6-byte transmission destination MAC address stored in the state management register 620. The transmission data generation section 610 transmits the transmission result S5 to the controller 320.

The controller 320 confirms correct transmission based on the transmission result. The controller 320 then references the microcode table 440 to extract an instruction the transmission data generation section 610 processes next. The microcode interpretation section 412 changes the instruction to the control signal S6 that is then transmitted to the transmission data generation section 610. As a result of referencing the microcode table 440, the controller 320 may extract an instruction to specify the process of transmitting transmission data that is the MAC address of the communication terminal 300 itself stored in the state management register 620. In this case, the controller 320 transmits the control signal S6 that conforms to the instruction. In addition to the above-mentioned process, the transmission data generation section 610 can generate transmission data using the transfer data.

The following describes a transmission data generation process using transfer data when Ethercat is specified. As transmission data, Ethercat uses received data as is, partly modified received data, or data stored in the first memory 331.

When received data is used as is, the controller 320 assigns a transmission data length to the state management register 620. The transmission/reception data control section 314 supplies transfer data S11. The controller 320 supplies the transmission data generation section 610 with an instruction for transmitting the transfer data S11 as transmission data so as to conform to the value indicated by the state management register 620.

When received data is partly modified, the controller 320 transmits the position of modified data and the modification method to the transmission data generation section 610 before the transmission/reception data control section 314 transmits the data S11 to be modified partly. When data transmitted from the transmission/reception data control section 314 is modified, an FCS value of the transmission data also needs to be changed. When transmission data is generated, the transmission buffer 630 and the arithmetic logical unit 611 are used to always calculate the FCS. The calculation result is used when the FCS value needs to be changed.

When data saved in the first memory 331 is used as transmission data, the controller 320 allocates the data saved in the first memory 331 to the transmission buffer 630. In addition, the controller 320 notifies the transmission data generation section 610 of a position to insert the data saved in the first memory 331 and a stored address. The transmission data generation section 610 inserts the data saved in the transmission buffer 630 into the position indicated by the controller 320 and transmits that data as transmission data.

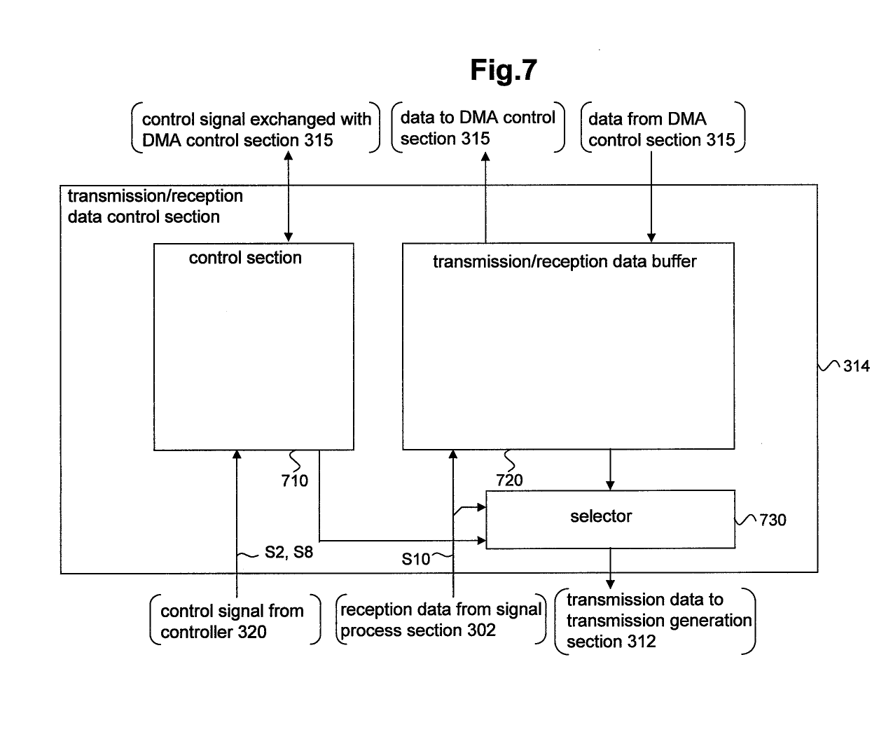

FIG. 7 exemplarily shows the hardware configuration of the transmission/reception data control section 314. The transmission/reception data control section 314 provides control so as to transmit received data to the other communication terminals and transmit received data to the second memory 341 via the DMA control section 315. The transmission/reception data control section 314 includes a control section 710, a transmission/reception data buffer 720, and a selector 730.

Reception data S10 is directly supplied from the signal process section 302 and is saved in the transmission/reception data buffer 720. The data S10 is also transmitted as transfer data to the transmission generation section 312 via the selector 730 in accordance with a value in the transfer timing register 423. The control section 710 controls this process. When the transfer timing register 423 contains value 0, for example, the control section 710 uses the selector 730 to enable a path for transmitting received data as is to the transmission generation section 312. When the transfer timing register 423 contains value 10, the control section 710 does not enable the path for transmitting received data as is to the transmission generation section 312. The control section 710 transmits reception data as transmission data saved in the transmission/reception data buffer 720 after a lapse of ten cycles from the time the beginning of reception data is transmitted. Instead of the transmission/reception data control section 314, the transmission generation section 312 may provide control using the transfer timing register 423. In this case, it is necessary to configure a path for transmitting received data as is to the transmission generation section 112.

As mentioned above, the setup value of the cut/through mode register 422 may be used to determine whether or not reception data is directly transmitted as transmission data to the transmission generation section 412.

The controller 320 may supply the signal S2 for transmitting data stored in the transmission/reception data buffer 720 to the second memory 341 via the DMA control section 315. In such case, the transmission/reception data control section 314 notifies the DMA control section 315 of information such as the save destination address, the length of data to be saved, and the position for saving the data.

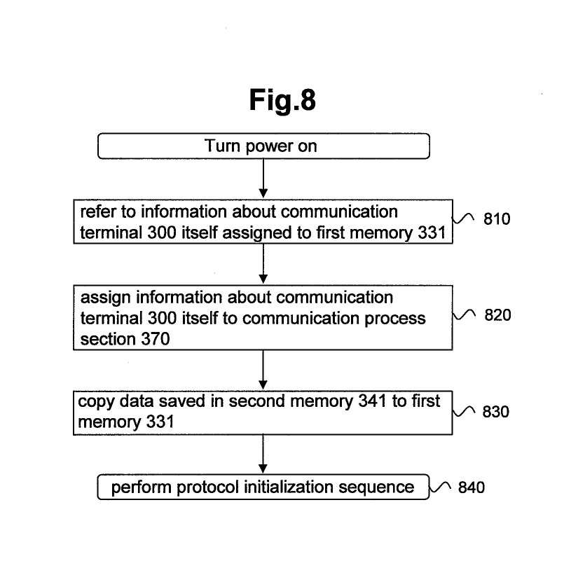

FIG. 8 exemplarily shows a startup sequence immediately after turning on the communication terminal 300.

After the power is turned on, the communication terminal 300 references information about itself stored in the second memory 341 (Step 810). Using the reference result, the communication terminal 300 configures information setting for the communication process section 370 (Step 820). The setting includes addresses of the communication terminal 300 and a transmission origin as well as the protocol used for the data communication. The setting is used to initialize the communication mode register 421, the cut/through mode register 422, transfer timing register 423, and the communication protocol register 426.

The communication terminal 300 copies data saved in the second memory 341 to the first memory 331 in accordance with an application and a service available for the communication terminal 300 (Step 830). At this time, the communication terminal 300 also configures settings for the memory control register 424 and the memory synchronization register 425.

Finally, the communication terminal 300 performs an initialization sequence compliant with the protocol used for the data communication to terminate the startup sequence (Step 840).

The following describes an Ethercat initialization sequence as an example of protocol initialization sequences.

Ethercat does not use MAC addresses used for ETHERNET. According to Ethercat, the master 100 provides slaves with 2-byte addresses that are effective only in the Ethercat network. To do this, the master 100 transmits a 2-byte address to the slave A110. The slave A110 receives the 2-byte address, assumes it to be its own address, increments the address by 1, and transmits the incremented value to the slave B120.

The slave B120 performs the similar process and transmits the value to the slave C130. The similar process is subsequently performed to settle the 2-byte addresses.

According to the industrial Ethernet, referencing the frame type can determine the communication protocol the master 100 transmits. The microcode may be acquired via the second memory 341 during the initialization sequence compliant with the protocol so as to be assigned to the communication process section 370.

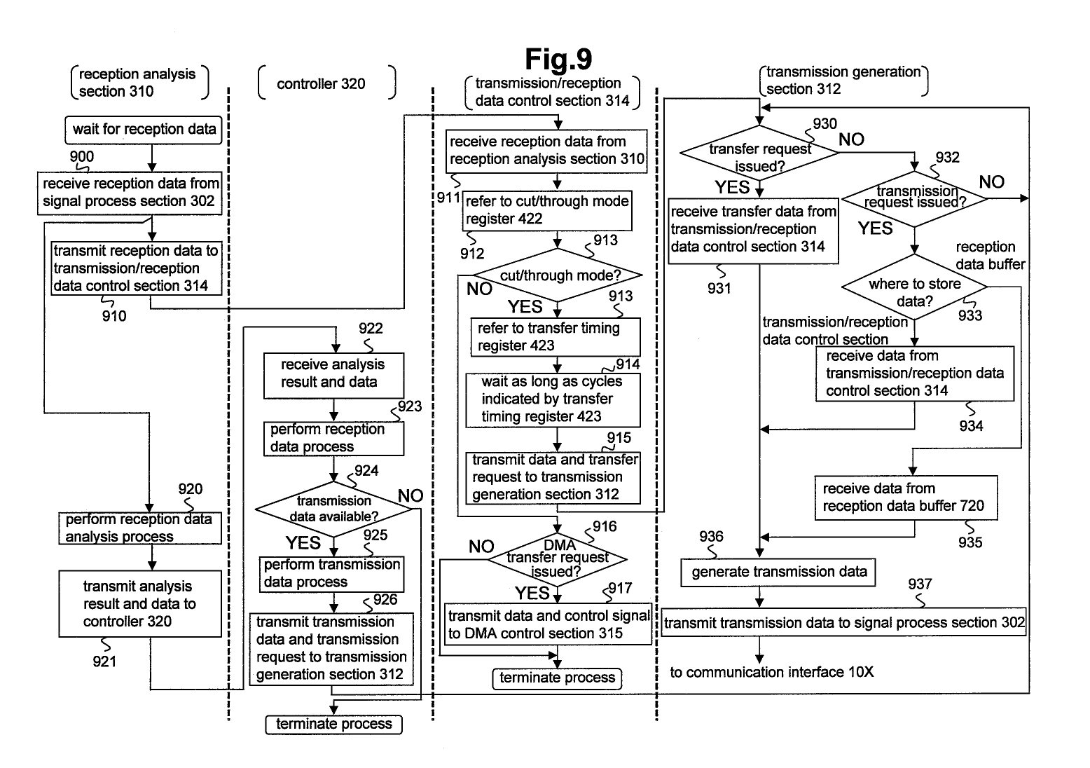

FIG. 9 exemplarily shows a flow of processing data received from the signal process section 302.

The reception analysis section 310 receives reception data from the signal process section 302 and then supplies the data to the reception data analysis section 510 and the transmission/reception data control section 314 (Steps 900, 910, and 920).

At Step 910, reception data is supplied to the transmission/reception data control section 314 with no need to perform a special process in the reception analysis section 310 as shown in FIG. 5. Reception data may be processed in the reception data analysis section 510 as needed and then may be transmitted to the transmission/reception data control section 314.

The following describes a flow of the reception data transmitted to the transmission/reception data control section 314.

The transmission/reception data control section 314 receives the reception data from the reception analysis section 310 and stores the data in the transmission/reception data buffer 720. The transmission/reception data control section 314 then references the cut/through mode register 422 and determines whether the communication terminal 300 is assigned the cut mode or the through mode as the operation mode (Steps 911 to 913).

The reception data need not be transmitted to the other communication terminals when the communication terminal 300 is assigned the cut mode, not the through mode, as the operation mode. In this case, the transmission/reception data control section 314 skips the process of transferring the data to the transmission generation section 312 and determines whether or not the controller 320 issues a DMA transfer request (Step 916).

When a DMA transfer request is issued from the controller 320, the transmission/reception data control section 314 supplies the DMA control section 315 by transmission with information needed for saving the reception data stored in the transmission/reception data buffer 720 to the second memory 341. The information includes the data length and save destination and origin addresses for the DMA transfer, for example. The transmission/reception data control section 314 then terminates the process (Step 917). Instead of the DMA transfer request, the controller 320 may transmit a request for saving reception data stored in the transmission/reception data buffer 720 to the first memory 331.

When no DMA transfer request is issued from the controller 320, the transmission/reception data control section 314 discards the reception data stored in the transmission/reception data buffer 720 and then terminates the process. The reception data may be saved in the transmission/reception data buffer 720 as needed.

When the communication terminal 300 is assigned the through mode as the operation mode, the reception data needs to be transmitted to the other communication terminals. In this case, the transmission/reception data control section 314 performs the process of supplying data to the transmission generation section 312. The following describes the transfer process.

When determining that the transfer is needed, the transmission/reception data control section 314 references the transfer timing register 423 and acquires the transfer timing (Step 913). When the transfer timing register 423 contains value 0, the transmission/reception data control section 314 stores the reception data in the transmission/reception data buffer 720 and transmits the reception data to the transmission generation section 312. When the transfer timing register 423 contains a value other than 0, the transmission/reception data control section 314 uses the selector 730 for not transferring reception data as mentioned above. The transmission/reception data control section 314 stores the reception data only in the transmission/reception data buffer 720. The transmission/reception data control section 314 delays the transfer as long as the number of cycles indicated by the transfer timing register 423, and then transmits the reception data stored in the transmission/reception data buffer 720 (Steps 914 and 915).

Instead of the transmission/reception data control section 314, the reception analysis section 310 may perform the above-mentioned transfer process.

When a transfer request is issued from the transmission/reception data control section 314, the transmission generation section 312 receives the transfer data from the transmission/reception data control section 314. The transmission generation section 312 generates transmission data based on the transfer data and supplies the transmission data to signal process section 302 (Steps 930, 931, 936, and 937).

The controller 320 controls the transmission generation section 312 so as to generate transmission data based on the transfer data. The control method uses the above-mentioned microcodes and a detailed description is omitted for simplicity.

The following describes the process flow subsequent to the reception data analysis process (Step 920).

Based on a control signal transmitted from the controller 320, the reception analysis section 310 analyzed reception data using the arithmetic logical unit 511 in the reception data analysis section 510. The reception data analysis method conforms to the control method using the above-mentioned microcodes and a detailed description is omitted for simplicity (Step 920).

When the analysis is completed, the reception analysis section 310 transmits the reception data to the controller 320 as needed in accordance with the analysis result (Step 921).

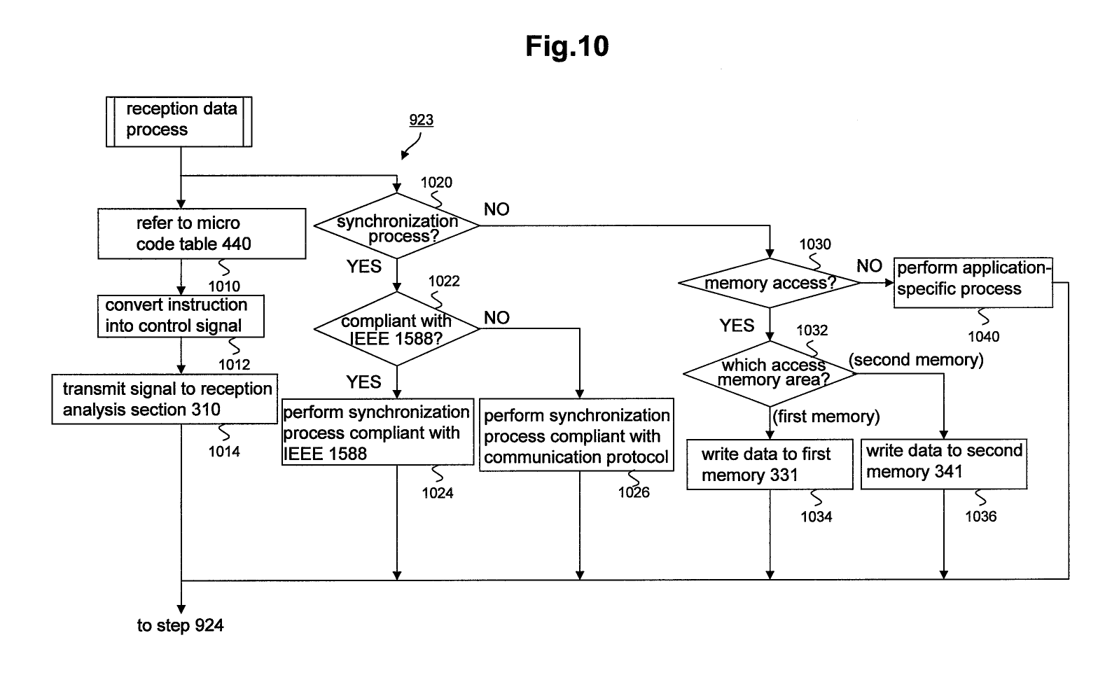

The controller 320 receives the analysis result and the reception data and then performs the analysis result process (Step 923). The analysis result process will be described later with reference to FIG. 10.

The controller 320 references the microcode table 440 based on the received analysis result and acquires an instruction the reception analysis section 310 processes next. The controller 320 allows the microcode interpretation section 412 to convert the acquired instruction into a control signal and then transmits the signal to the reception analysis section 310 (Steps 1010, 1012, and 1014).

A synchronization process may be needed depending on the received analysis result. In such case, the controller 320 performs the synchronization process parallel to Steps 1010 through 1014 (Step 1020). The synchronization process provides synchronization between communication terminals over the network so as to ensure the real-time property for the communication terminals. Two types of synchronization methods are available, i.e., a synchronization system compliant with IEEE 1588 and a synchronization system compliant with communication protocols (Steps 1022, 1024, and 1026).

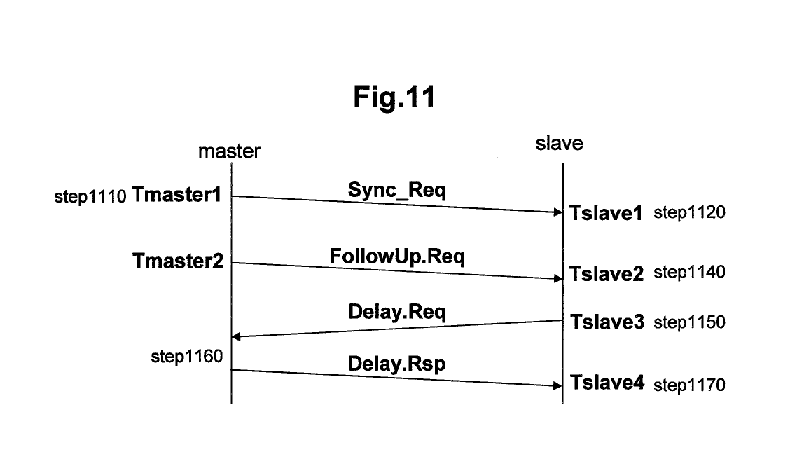

The synchronization system compliant with IEEE 1588 will be described with reference to FIG. 11. Let us suppose that a transmission delay occurs between the master 100 and the slave A110 and the transmission delay time is assumed to be T. The master 100 assigns a frame with time Tmaster1 to transmit data from the master itself and transmits the frame to the slave A110 (Step 1110). The slave A110 receives the frame and finds a difference between time Tslave1 to receive the frame and the time assigned to the frame (Step 1120). For example, let us suppose that Tmaster1 is 100 and Tslave1 is 91. Then, the difference is −9. It is clear that an error of −9 exists between the master 100 and the slave A110 even though transmission delay time T is unknown.

The slave A110 corrects the difference. The slave A110 itself needs to confirm that the slave A110 is accurately corrected. For this purpose, the master 100 assigns time Tmaster2 to a frame and transmits the frame to the slave A110 (Step 1130).

The slave A110 receives the frame and finds a difference between time Tslave2 to receive the frame and the time assigned to the frame (Step 1140). The difference is 0 because of the correction.

After the correction is completed, the sequence proceeds to a procedure for finding transmission delay time T.

The slave A110 transmits a delay request to the master 100 (Step 1150). The slave A110 saves time Tslave3 to transmit the delay request in the memory, for example.

The master 100 receives the delay request and immediately transmits a delay response to the slave A110 (Step 1160). The slave A110 receives the delay response, saves time Tslave4 to receive the delay response in the memory, for example, and finds transmission delay time T from Tslave3 and Tslave4 (Step 1170).

The real-time clock 431 included in the synchronization control section 430 is used to acquire the time needed for synchronization processes compliant with IEEE 1588. There has been described the flow synchronization system compliant with IEEE 1588.

In FIG. 10, the controller 320 performs a memory access process (Step 1030) instead of the synchronization process in parallel with Steps 1010 through 1014 when an access to the memory is needed.

The memory access process accesses the first memory 331 or the second memory 341 to read or write data. The memory control register 424 is used as an available memory area. As methods of using the memory control register 424, the controller 320 configures accessible memory in the memory control register 424 during a startup sequence. In addition, the memory control register 424 selects the memory to be accessed in accordance with a memory address transmitted from the master (Steps 1032, 1034, and 1036).

The controller 320 may perform an application-specific process as needed (Step 1040) instead of the synchronization process or the memory access process in parallel with Steps 1010 through 1014.

Based on the analysis result, the controller 320 performs the memory access process or the application-specific process that may then require to transmit transmission data. In such case, the controller 320 performs a transmission data process (Steps 924 and 925). In the transmission data process, the controller 320 assigns data targeted for transmission to the transmission buffer 630 in the transmission generation section 312. The controller 320 notifies the transmission generation section 312 of the availability of data to be transmitted and the transmission timing. The transmission data may be assigned to the transmission/reception data buffer 720 in the transmission/reception data control section 314 instead of the transmission buffer 630.

The transmission generation section 312 receives a transmission request, confirms the place of storing the transmission data, generates transmission data using that data, and transmits the generated data to the signal process section 302 (Steps 930, 931, 936, and 937).

The controller 320 controls the transmission generation section 312 to generate transmission data. The control method uses the above-mentioned microcodes and a detailed description is omitted for simplicity.

The first embodiment mentioned above provides the following working effects.

(1) The reception port and the transmission port can be allocated independently in accordance with the setting of the register 422. When data is received from the communication interface, the received packet can be not only successively analyzed but also directly transmitted as transmission data for the other port. The embodiment is applicable to various network topologies such as line and tree types. The register 423 can set the timing for transmission to the other port. The embodiment is flexibly applicable to various networks.

(2) Based on a microcode, the embodiment provides control to successively analyze a received packet and successively generate a packet to be transmitted. The microcode is saved in the rewritable memories 341 and 440. This makes it possible to change the microcode. The embodiment is applicable to various communication protocols. The setting of the register 421 can specify the communication protocol.

(3) As mentioned above, the embodiment is applicable to various communication protocol processes including the real-time communication protocol at low cost.

### Second Embodiment

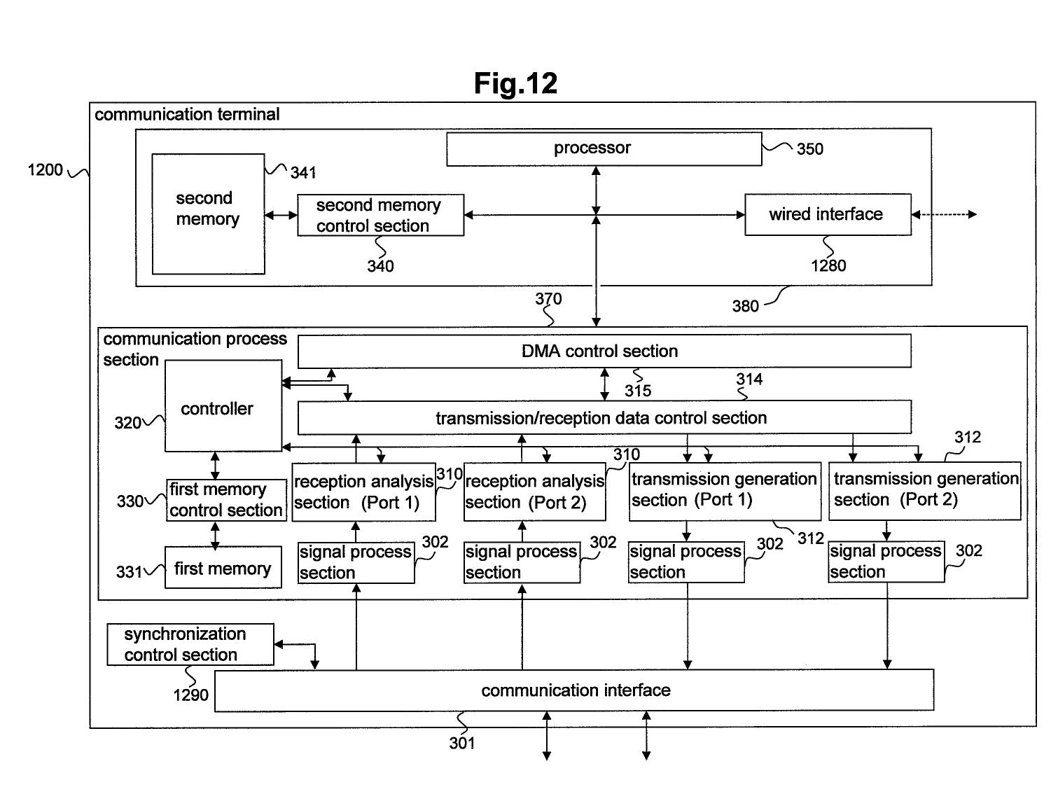

FIG. 12 exemplarily shows the hardware configuration of a communication terminal according to the second embodiment. The following mainly describes differences from the first embodiment.

A communication terminal 1200 includes a communication interface 301, a signal process section 302, a reception analysis section 310, a transmission generation section 312, a transmission/reception data control section 314, a DMA control section 315, a controller 320, a first memory control section 330, first memory 331, a second memory control section 340, second memory 341, a processor 350, a wired interface 1280, and a synchronization control section 1290.

The communication terminal 1200 may be provided with a magnetic disk unit or other storage units and a display panel (not shown) in accordance with services and applications available for the communication terminal 1200.

Differently from the communication terminal 300 according to the first embodiment, the communication terminal 1200 according to the second embodiment uses the wired interface 1280, provides the synchronization control section 1290 outside the controller 320, and is capable of directly communicating with the communication interface 301. The other components of the communication terminal 1200 are the same as those of the first embodiment and a detailed description is omitted for simplicity.

The use of the wired interface 1280 makes it possible to access a network other than the network based on the communication interface 301. The wired interface 1280 may be replaced by a wireless interface.

According to the first embodiment, the communication terminal 300 is applicable to various communication protocols. For this purpose, the second memory 341 previously saves microcodes that are compliant with various communication protocols and are used for control over the reception analysis section 310 and the transmission generation section 312. When the power is turned on, the microcode is allocated to the microcode table 440 in accordance with the communication protocol the communication terminal 300 performs. Since the communication terminal 300 is applicable to many communication protocols, however, the second memory 341 needs to save multiple microcodes and requires a large capacity. To solve this problem, all microcodes are saved in a server on an outside network. The server may be accessed at startup so as to download a microcode to the microcode table 440. This method makes it possible to eliminate the need to use large-capacity memory for microcodes and reduce costs for the communication terminal 1200.

Directly coupling the synchronization control section 1290 to the communication interface 301 can reduce an influence of internal operation delay on the synchronization control due to the real-time clock.

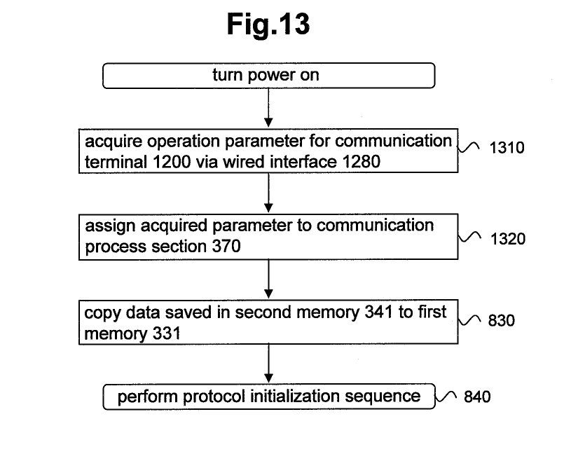

FIG. 13 exemplarily shows a startup sequence after turning on the communication terminal 1200.

After the power is turned on, the communication terminal 1200 acquires a microcode and a parameter needed for operations of the communication terminal 1200 via the wired interface 1280 (Step 1310).

The communication terminal 1200 assigns the acquired microcode and parameter to the communication process section 370 (Step 1310).

The communication terminal 1200 copies data saved in the second memory 341 to the first memory 331 in accordance with an application and a service available for the communication terminal 1200 (Step 1330).

The server may store data saved in the second memory 341. In this case, data is copied to the first memory 331 via the wired interface 1280.

Finally, the communication terminal 1200 performs an initialization sequence compliant with the protocol used for the data communication to terminate the startup sequence (Step 1340).

According to the industrial Ethernet, referencing the frame type can determine the communication protocol the master 100 transmits. The microcode may be acquired via the wired interface 1280 during the initialization sequence compliant with the protocol so as to be assigned to the communication process section 370.

Ability to access the other network eliminates the need for saving microcodes and the use of the second memory 341 itself.

The communication terminal 1200 is configured to not only include the wired interface 1280 but also ensure communication between the synchronization control section 1290 and the communication interface 301.

As described with reference to FIG. 11, the synchronization process requires the time to transmit or receive data. The process flow according to the first embodiment performs the analysis process in the reception analysis section 310 and the controller 320 and then starts the synchronization process. Such process flow may be incapable of a synchronization process for the protocol that requires the synchronization accuracy in units of nanoseconds (ns). To solve this problem, the communication terminal 1200 is configured to ensure direct communication between the synchronization control section 1290 and the communication interface 301. The communication terminal 1200 can acquire more accurate time to transmit or receive data.

In the other aspects, the second embodiment also provides the same working effects as the first embodiment.

While there have been described specific preferred embodiments of the present invention, it is to be distinctly understood that the present invention is not limited thereto but may be otherwise variously embodied within the spirit and scope of the invention.

For example, the respective communication ports may be configured to use the same signal line for transmission and reception in addition to the configuration that uses different signal lines for concurrent transmission and reception as shown in FIG. 1.

The description of the embodiments provides examples of the communication terminals using the communication data processor and the communication data processing method. The present invention is not limited thereto and is widely applicable to various communication control devices used for the industrial Ethernet.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A communication data processor comprising:
a data process section;
a communication interface comprising a plurality of outside interface ports; and
a communication process section that performs communication control using the communication interface in accordance with a setting of the data process section,
wherein the communication process section comprises:
rewritable memory that stores a program code for program control over the communication process section in accordance with a specified communication protocol; and
a first mode register that specifies an operation of transmitting data received via the communication interface from a port different from a receiving port, and
wherein the communication process section references the first mode register and controls transmission/reception via the communication interface in accordance with a program code stored in the memory.

2. The communication data processor according to claim 1,
wherein the communication process section comprises a timing register that variably specifies timing of transmission from the different port.

3. The communication data processor according to claim 2,
wherein the communication process section comprises a second mode register that is assigned with data indicating a communication protocol corresponding to a program code stored in the memory.

4. The communication data processor according to claim 3,
wherein the data process section comprises:
a processor that accesses the first mode register, the second mode register, and the timing register.

5. The communication data processor according to claim 3,
wherein the communication process section analyzes input reception data and provides communication control based on an analysis result, and
wherein the communication process section provides control of outputting the input reception data from another port in accordance with settings of the second mode register and the timing register independently of completion of control based on the analysis result.

6. The communication data processor according to claim 1,
wherein the data process section comprises nonvolatile memory that contains a program code to be stored in the memory, and
wherein the data process section initially allocates a program code from the nonvolatile memory to the memory.

7. The communication data processor according to claim 1,
wherein the data process section comprises an input circuit, and
wherein the data process section initially allocates a program code supplied from the input circuit to the memory.

8. A communication data processing method for communication control using a data process section, a communication interface comprising a plurality of outside interface ports, and a communication process section that performs communication control using the communication interface in accordance with a setting of the data process section, the method comprising the steps of:
allowing the data process section to store a program code in rewritable memory, wherein the program code is used for program control over the communication process section in accordance with a specified communication protocol;
allowing the data process section to assign data to a first mode register of the communication process section, wherein the data specifies a transmission port using a port different from a reception port for the communication interface; and
allowing the communication process section to reference setup data in the first mode register and perform a transmission/reception operation in accordance with a program code stored in the memory.

9. The communication data processing method according to claim 8, comprising the steps of:
allowing the data process section to assign a timing register of the communication process section with data that variably specifies timing of transmission from the different port; and
allowing the communication process section to control timing to transmit data received through the communication interface in accordance with setup data in the timing register.

10. The communication data processing method according to claim 9, further comprising a step of:
allowing the data process section to assign a second mode register of the communication process section with data that indicates a communication protocol corresponding to a program code stored in the memory.
